(19) United States
(12) Patent Application Publication
(10) Pub. No.: US 2026/0252285 A1
(43) Pub. Date: Aug. 27, 2026

(54) PRINTING APPARATUS AND PROGRAM

(71) Applicant: Seiko Instruments Inc., Chiba-shi (JP)

(72) Inventors: Daisuke YOSHIDA, Chiba-shi (JP); Shohei NOMURA, Chiba-shi (JP); Hiroaki KONDO, Chiba-shi (JP); Ren KANNO, Chiba-shi (JP); Ryuji UNO, Chiba-shi (JP)

(21) Appl. No.: 19/548,508

(22) Filed: Feb. 24, 2026

(30) Foreign Application Priority Data
Feb. 26, 2025 (JP) 2025-028835

(51) Int. Cl. G06F 3/12; B41J 2/35; B41J 29/393

(52) U.S. Cl. CPC G06F 3/1229; B41J 2/35; B41J 29/393; G06F 3/1221; G06F 3/1292

(57) ABSTRACT

A printing apparatus includes: a power supply unit configured to supply electric power to a print head configured to perform printing based on rendering data, a control device which includes a rendering data generation module configured to generate the rendering data from print data provided from a host device, and a separate device which is a device other than the print head and the control device; and a distribution unit configured to distribute the electric power supplied by the power supply unit to the control device, the print head, and the separate device. The control device includes: an acquisition module configured to acquire the print data; a distribution control module configured to switch between a first state in which the electric power distributed to the separate device is not reduced and a second state in which the electric power distributed to the separate device is reduced, at an asynchronous timing with respect to an acquisition timing of the print data; and a printing control module configured to start, after receiving the print data, a rendering data generation operation by the rendering data generation module to generate the rendering data from the print data in the first state, and to start, after switching from the first state to the second state, a printing operation by the print head based on the rendering data.

### RELATED APPLICATIONS

This application claims priority to Japanese Patent application No. JP2025-028835, filed on Feb. 26, 2025, the entire content of which is incorporated herein by reference.

### BACKGROUND OF THE INVENTION

### 1. Field of the Invention

The present invention relates to a printing apparatus and a program.

### 2. Description of the Related Art

Hitherto, a printing apparatus which can both supply electric power to an external device and process information has been proposed.

With the above-mentioned related art, control is complex, and as a result, there is a problem in that when inexpensive components having a relatively low performance are used in a power supply circuit and a control circuit, it is difficult to simultaneously supply electric power to the external device (for example, a separate device such as a portable charger, a smartphone, or a tablet device) and perform a printing operation.

An object of the present invention is to achieve both power supply to a separate device and a printing operation even when inexpensive components having a relatively low performance are used in a power supply circuit and a control circuit.

### SUMMARY OF THE INVENTION

According to one embodiment of the present invention, there is provided a printing apparatus including: a power supply unit configured to supply electric power to a print head configured to perform printing based on rendering data, a control device which includes a rendering data generation module configured to generate the rendering data from print data provided from a host device, and a separate device which is a device other than the print head and the control device; and a distribution unit configured to distribute the electric power supplied by the power supply unit to the control device, the print head, and the separate device, the control device including: an acquisition module configured to acquire the print data; a distribution control module configured to switch between a first state in which the electric power distributed to the separate device is not reduced and a second state in which the electric power distributed to the separate device is reduced, at an asynchronous timing with respect to an acquisition timing of the print data; and a printing control module configured to start, after receiving the print data, a rendering data generation operation by the rendering data generation module to generate the rendering data from the print data in the first state, and to start, after switching from the first state to the second state, a printing operation by the print head based on the rendering data.

In the above-mentioned printing apparatus according to the one embodiment of the present invention, wherein the printing control module is configured to suspend, when the rendering data generation operation ends before switching from the first state to the second state, start of the printing operation by the print head until switching from the first state to the second state.

In the above-mentioned printing apparatus according to the one embodiment of the present invention, wherein when the printing operation by the print head has started, the distribution control module is configured to avoid switching from the second state to the first state until the printing operation ends, and to switch from the second state to the first state after the printing operation ends.

In the above-mentioned printing apparatus according to the one embodiment of the present invention, wherein the asynchronous timing is a periodic timing.

In the above-mentioned printing apparatus according to the one embodiment of the present invention, wherein a function operating in the second state includes at least one of a detection unit configured to detect an operating state of the printing apparatus by using the electric power supplied, or a wireless communication unit configured to perform wireless communication to and from an external device by using the electric power supplied.

In the above-mentioned printing apparatus according to the one embodiment of the present invention, wherein the separate device is a device which has a function of storing electric power supplied from the power supply unit.

According to one embodiment of the present invention, there is provided a program for causing a computer of a printing apparatus including: a power supply unit configured to supply electric power to a print head configured to perform printing based on rendering data, a control device which includes a rendering data generation module configured to generate the rendering data from print data provided from a host device, and a separate device which is a device other than the print head and the control device; and a distribution unit configured to distribute the electric power supplied by the power supply unit to the control device, the print head, and the separate device, to execute: acquiring the print data; switching between a first state in which the electric power distributed to the separate device is not reduced and a second state in which the electric power distributed to the separate device is reduced, at an asynchronous timing with respect to an acquisition timing of the print data; and starting, after receiving the print data, a rendering data generation operation by the rendering data generation module to generate the rendering data from the print data in the first state, and starting, after switching from the first state to the second state, a printing operation by the print head based on the rendering data.

According to at least one embodiment of the present invention, it is possible to achieve both power supply to a separate device and the printing operation even when inexpensive components having a relatively low performance are used in the power supply circuit and the control circuit.

### BRIEF DESCRIPTION OF THE DRAWINGS

FIG. 1 is a diagram for illustrating an example of a function configuration of a printing system in at least one embodiment of the present invention.

FIG. 2 is a flow chart for illustrating an example of a flow of a control operation of a control device in the at least one embodiment.

FIG. 3 is a timing chart for showing an example of timing of the control operation of the control device in the at least one embodiment.

### DETAILED DESCRIPTION OF THE PREFERRED EMBODIMENTS

A printing system 1 according to at least one embodiment of the present invention is described with reference to the drawings. The at least one embodiment described below is described merely as an example, and the present invention can be applied to any embodiment without being limited to the following at least one embodiment.

Throughout the drawings for illustrating the at least one embodiment, components having the same function are denoted by identical reference symbols, and a duplicate description thereof is omitted.

Further, “based on XX” as used herein means “based on at least XX,” including a case which is based on another element in addition to XX. Further, “based on XX” is not limited to a case in which XX is directly used, and a case which is based on an object obtained by performing calculation or processing on XX is also included. “XX” is any element (for example, any information).

### At Least One Embodiment

Now, referring to the drawings, the at least one embodiment of the present invention is described.

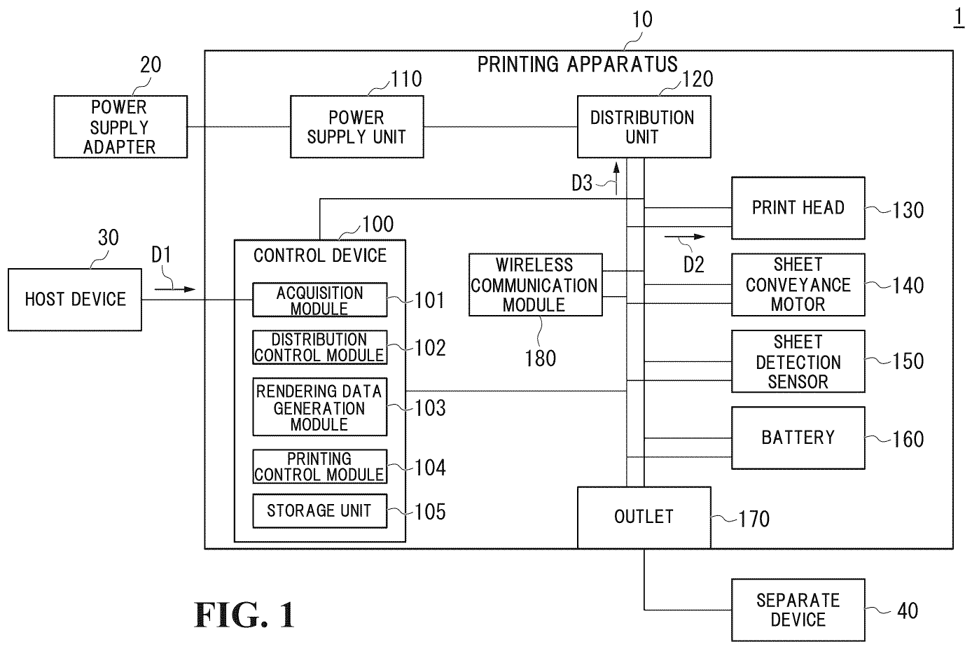

FIG. 1 is a diagram for illustrating an example of a function configuration of the printing system 1 in the at least one embodiment. The printing system 1 includes a printing apparatus 10, a power supply adapter 20, a host device 30, and a separate device 40.

The printing apparatus 10 is, for example, an apparatus such as a thermal printer, and includes a control device 100, a power supply unit 110, a distribution unit 120, a print head 130, a sheet conveyance motor 140, a sheet detection sensor 150, a battery 160, an outlet 170, and a wireless communication module 180.

The power supply unit 110 is electrically connected to the power supply adapter 20. The power supply adapter 20 includes, for example, a switching power supply circuit and a series power supply circuit. The power supply adapter 20 converts AC power supplied from a commercial power supply outlet into DC power for operating the printing apparatus 10, and supplies the DC power to the printing apparatus 10. The power supply unit 110 supplies the electric power supplied from the power supply adapter 20 to the distribution unit 120.

Supplying electric power to the power supply unit 110 from the power supply adapter 20 is merely one example, and the manner in which electric power is supplied to the power supply unit 110 is not limited to this. For example, the power supply unit 110 may incorporate the function of the power supply adapter 20, and be supplied with electric power from the commercial power supply outlet.

Further, the power supply adapter 20 may be a battery device which stores electricity.

The power supply unit 110 supplies operating power to each component of the printing apparatus 10 via the distribution unit 120.

The distribution unit 120 includes, for example, a switch circuit and an inverter circuit, and distributes the electric power supplied from the power supply unit 110 to each component of the printing apparatus 10 under the control of the control device 100. In one example of the at least one embodiment, the distribution unit 120 distributes electric power to, of the various components of the printing apparatus 10, at least the control device 100, the print head 130, and the sheet conveyance motor 140, and, via the outlet 170, to the separate device 40.

That is, the distribution unit 120 distributes the electric power supplied by the power supply unit 110 to the control device 100, the print head 130, and the separate device 40.

The print head 130 performs printing based on rendering data D2. The print head 130 includes an element which generates heat by using the supplied electric power, and prints graphics and characters based on the rendering data D2 onto thermal paper.

In the example of the at least one embodiment, a case in which the printing apparatus 10 is a thermal printer and the print head 130 prints on thermal paper is taken as an example for description, but the present invention is not limited to this. The print head 130 is only required to have a function of printing by using electric power supplied from the power supply unit 110, and may perform printing by using a method other than thermal printing.

The sheet conveyance motor 140 conveys a printing sheet to the print head 130.

The sheet detection sensor 150 detects a presence/absence and a position of a printing sheet which is fed to the print head 130. For example, the sheet detection sensor 150 is a photointerrupter that includes a light emitting element and a light receiving element, and detects the presence/absence and the position of a printing sheet when light emitted from the light emitting element is reflected by the printing sheet and is incident on the light receiving element (or, is blocked by the printing sheet and is not incident on the light receiving element). The sheet detection sensor 150 operates by using the electric power supplied from the power supply unit 110.

The outlet 170 is a connector which supplies electric power to the outside by using, for example, a general-purpose serial communication interface.

The wireless communication module 180 performs wireless communication to and from devices external to the printing apparatus 10 (hereinafter referred to as “external devices”), such as the host device 30.

A case in which the printing apparatus 10 of the at least one embodiment is wirelessly connected between the host device 30 and the control device 100 to acquire print data D1 is taken as an example for description, but the present invention is not limited to this. The printing apparatus 10 may be connected between the host device 30 and the control device 100 by a wired connection.

The separate device 40 is a device other than the printing apparatus 10, for example, a portable charger, a smartphone, or a tablet device, which has a power storage function. The electric power output by the power supply unit 110 is supplied to the separate device 40. That is, the separate device 40 is a device which has a function of storing electric power supplied from the power supply unit 110. Further, the separate device 40 may be a display or the like that does not have a power storage function, in which case the electric power output by the power supply unit 110 is supplied as electric power for driving the display or the like.

That is, the separate device 40 may be any device that stores electric power or consumes electric power by receiving electric power from the printing apparatus 10, and the type of the device is not limited.

In addition, the distribution unit 120 may distribute electric power to the battery 160 instead of or in addition to the separate device 40.

The battery 160 has a function of storing the electric power supplied from the power supply unit 110. The battery 160 supplies electric power to the power supply unit 110 when the power supply adapter 20 is not connected to the power supply unit 110. In this case, the printing apparatus 10 functions as a portable (mobile) device that can print even when not connected to a commercial power supply.

The battery 160 and the separate device 40 are common in terms of the point that those devices both have a power storage function. That is, the battery 160 and the separate device 40 are both devices which have a power storage function. In the following description, when it is not required to distinguish between the separate device 40 and the battery 160, the separate device 40 and the battery 160 are collectively referred to as “separate device 40” instead of “the separate device 40 and the battery 160.”

As described above, the distribution unit 120 distributes the electric power supplied from the power supply unit 110 to the control device 100, the print head 130, and the separate device 40. In other words, the power supply unit 110 can be said to supply electric power to the control device 100, the print head 130, and the separate device 40.

Specifically, the power supply unit 110 supplies electric power to the print head 130 which performs printing based on the rendering data D2, the control device 100 which includes a rendering data generation module 103 that generates the rendering data D2 from print data D1 provided by the host device 30, and the separate device 40 which is a device other than the print head 130 and the control device 100.

The control device 100 is a computer device which operates by using electric power supplied from the power supply unit 110 and controls each component of the printing apparatus 10. For example, the control device 100 includes a central processing unit (CPU), and operates based on programs and data stored in a storage unit 105, to thereby provide various functions.

The storage unit 105 includes, for example, a semiconductor memory (flash memory, random-access memory (RAM), or read-only memory (ROM)), and stores various types of information such as programs and data read out by the CPU of the control device 100.

The control device 100 includes, as function modules thereof, an acquisition module 101, a distribution control module 102, the rendering data generation module 103, and a printing control module 104.

The acquisition module 101 acquires print data D1 from the host device 30 via the wireless communication module 180 (or, in the case of wired communication, not via the wireless communication module 180; the same applies in the following description). The host device 30 is a device which generates or stores the print data D1. The host device 30 is, for example, a computer device which controls a point-of-sale (POS) register. In this example, the host device 30 generates print data D1 for printing a name and a price of a purchased item. The host device 30 outputs the generated print data D1 to the printing apparatus 10. The acquisition module 101 of the control device 100 acquires the print data D1 output by the host device 30 via the wireless communication module 180.

The distribution control module 102 controls a power distribution state by outputting a distribution instruction D3 to the distribution unit 120. The power distribution state can be a first state ST1 or a second state ST2.

The first state ST1 is a distribution state in which the electric power distributed to the separate device 40 is not reduced. The second state ST2 is a distribution state in which the electric power distributed to the separate device 40 is reduced.

The output of the distribution instruction D3 by the distribution control module 102 is performed at an asynchronous timing with respect to an acquisition timing of the print data D1 by the acquisition module 101.

That is, the distribution control module 102 switches between the first state ST1, in which the electric power distributed to the separate device 40 is not reduced, and the second state ST2, in which the electric power distributed to the separate device 40 is reduced, at an asynchronous timing with respect to the acquisition timing of the print data D1.

The rendering data generation module 103 generates rendering data D2 based on the print data D1. The rendering data D2 is, of the data for printing, data that is based on the structure and specifications of the print head 130.

In general, the print data D1 is coded data of a command regarding, for example, the characters to be printed, line break positions, and sheet feed. For example, the print data D1 is standardized data that can also be used in common by various types of printing apparatus other than printing apparatus 10.

Meanwhile, the rendering data D2 is data that corresponds to the specifications of the print head 130 in accordance with, for example, a size, number of pixels, and heat generation capacity of the print head 130. For example, the rendering data D2 is data that is specific to the type of the print head 130.

The rendering data generation module 103 generates the rendering data D2 by converting the print data D1 (for example, standardized data) output by the host device 30 into data specific to the print head 130, for example.

That is, the rendering data generation module 103 generates the rendering data D2 from the print data D1 provided by the host device 30.

The printing control module 104 controls a printing operation of the printing apparatus 10. In the at least one embodiment, the printing control module 104 receives the print data D1, then starts a rendering data D2 generation operation by the rendering data generation module 103 in the first state ST1 to generate the rendering data D2 from the print data D1, switches from the first state ST1 to the second state ST2, and then starts the printing operation by the print head 130 based on the rendering data D2.

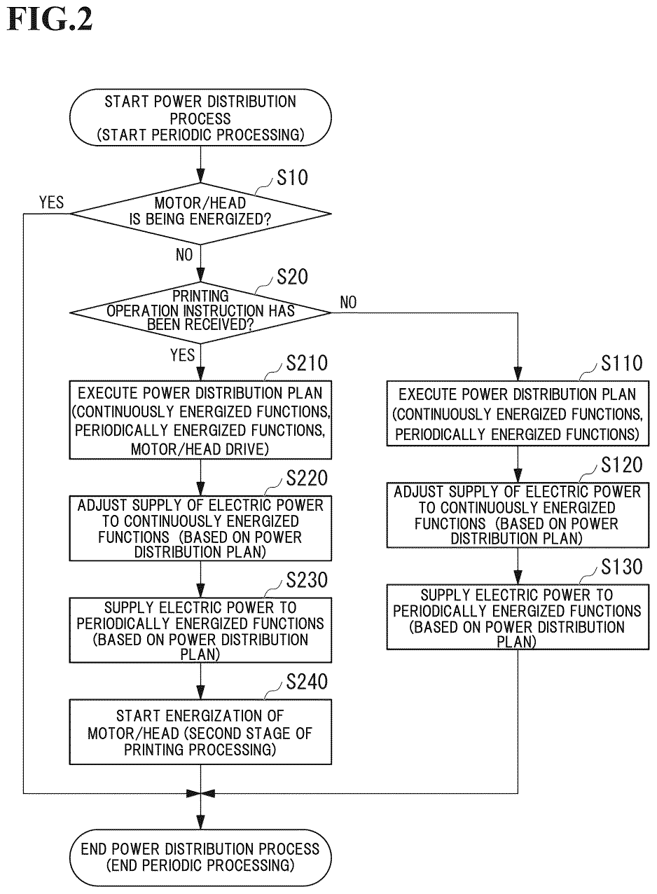

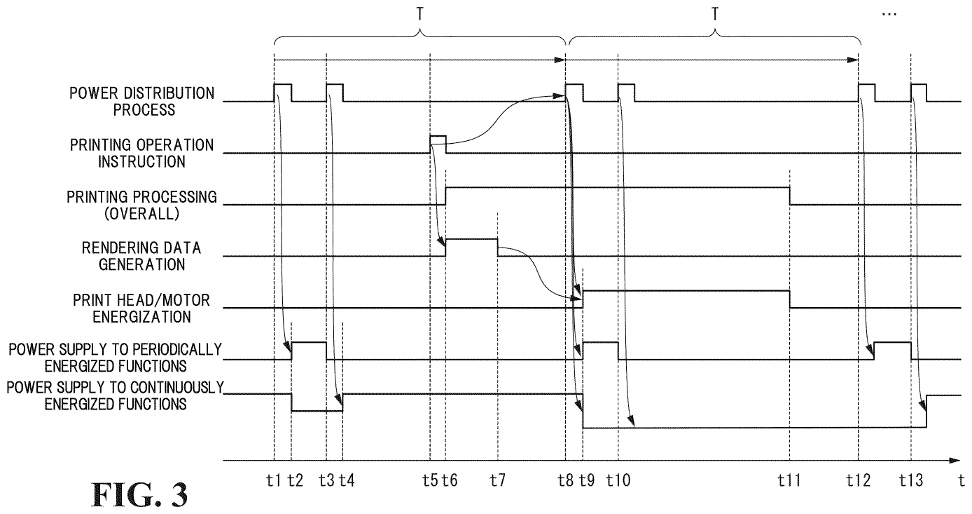

A specific example of a flow of a power distribution operation by the control device 100 is now described with reference to FIG. 2 and FIG. 3.

FIG. 2 is a flow chart for illustrating an example of a flow of a control operation by the control device 100 in the at least one embodiment.

FIG. 3 is a timing chart for showing an example of timing of the control operation by the control device 100 in the at least one embodiment.

The distribution control module 102 of the control device 100 switches the power distribution state (that is, first state ST1 and second state ST2) during a power distribution process. The control device 100 periodically starts the power distribution process. That is, the power distribution process is a periodically executed process scheduled by the control device 100. For example, the power distribution process is executed at a time t1, a time t8, a time t12, . . . , shown in FIG. 3.

As described above, the power distribution process by the distribution control module 102 is executed at an asynchronous timing with respect to the acquisition timing of the print data D1. In this example, “asynchronous timing” is a periodic timing.

For example, the time t1, the time t8, the time t12, . . . shown in FIG. 3 indicates that the power distribution process is executed periodically in accordance with an execution cycle T.

### (Step S10)

At the time t1 shown in FIG. 3, the printing control module 104 determines whether or not the print head 130 or the sheet conveyance motor 140 is currently being driven. When the printing control module 104 determines that the print head 130 or the sheet conveyance motor 140 is currently being driven (or is currently energized) (“YES” in Step S10), the power distribution process ends. An example of a case in which the print head 130 or the sheet conveyance motor 140 is currently being driven (or is currently energized) is when printing is in progress. That is, in a case in which printing is in progress at the timing when the power distribution process is started, the printing control module 104 does not switch the distribution of electric power.

In contrast, when the printing control module 104 determines that the print head 130 or the sheet conveyance motor 140 is not being driven (or is not energized) (“NO” in Step S10), the printing control module 104 advances the process to Step S20.

### (Step S20)

The printing control module 104 determines whether or not a printing operation instruction has been received from the host device 30. For example, when the acquisition module 101 acquires the print data D1 from the host device 30, the printing control module 104 determines that a printing operation instruction has been received from the host device 30. When the printing control module 104 determines that a printing operation instruction has been received (“YES” in Step S20), the printing control module 104 advances the process to Step S210. When the printing control module 104 determines that a printing operation instruction has not been received (“NO” in Step S20), the printing control module 104 advances the process to Step S110.

### (Step S110)

The distribution control module 102 executes a power distribution plan. The power distribution plan is processing of determining a power supply state of periodically energized functions and a power supply state of continuously energized functions.

### Periodically Energized Functions

Periodically energized functions are functions that may operate by using electric power that is periodically switched between a normal power supply and a reduced power supply (or the power supply is stopped) (for example, an intermittent power supply). Examples of periodically energized functions include the sheet detection sensor 150 and the wireless communication module 180. That is, the sheet detection sensor 150 and the wireless communication module 180 may operate intermittently by periodically switching between a normal power supply and a reduced power supply (or power supply is stopped).

When it is not required to reduce or stop electric power to the sheet detection sensor 150 or the wireless communication module 180, which are examples of periodically energized functions, the electric power is not required to be reduced or stopped. Whether or not it is required to reduce or stop electric power to the periodically energized functions is determined by the distribution control module 102 based on the results of the power distribution plan for the print head 130 and the sheet conveyance motor 140, which consume more electric power. Specifically, when there is a surplus of electric power available to be supplied as a result of executing the power distribution plan for the print head 130 and the sheet conveyance motor 140, the distribution control module 102 determines not to reduce or stop the electric power to the sheet detection sensor 150 and the wireless communication module 180. When there is no surplus of electric power available to be supplied, the distribution control module 102 determines to reduce or stop the electric power to the sheet detection sensor 150 and the wireless communication module 180.

For example, over a 10 ms period, the sheet detection sensor 150 is supplied with electric power for a 2 ms time interval and then electric power is stopped for an 8 ms time interval. In this case, the sheet detection sensor 150 has a ratio between the operating time and the stopped time of 1:5. As described above, the sheet detection sensor 150 includes, for example, a light emitting element. The lifespan of the light emitting element depends on the operating time (energization time). With the ratio between the operating time and the stopped time being set to 1:5, the lifespan of the light emitting element (that is, the sheet detection sensor 150) can be five times longer than when the light emitting element is operated continuously.

Further, for example, the wireless communication module 180 has a function of, when performing wireless communication to and from external devices, monitoring whether or not an external device is requesting a connection. In a case in which the wireless communication module 180 is continuously operating, the function of monitoring for connection targets is also continuously operating, meaning that power consumption is increased. In the at least one embodiment, the wireless communication module 180 operates intermittently, to thereby enable reduction in power consumption.

The periodically energized functions can also be said to be functions that operate in the second state ST2, in which the electric power distributed to the separate device 40 is reduced. In other words, the function(s) which operate in the second state ST2 include at least one of the sheet detection sensor 150 (detection unit) which detects an operating state of the printing apparatus 10 by using the electric power supplied, or the wireless communication module 180 (wireless communication unit) which performs wireless communication to and from an external device by using the electric power supplied.

In addition, depending on the status of power supply and power consumption, there may be cases in which it is not required to reduce the electric power distributed to the separate device 40 during operation of the periodically energized functions (for example, the sheet detection sensor 150 and the wireless communication module 180). That is, the periodically energized functions can be said to be functions that operate in a state in which the electric power distributed to the separate device 40 is not reduced depending on the status of power supply and power consumption, and functions that operate in the second state ST2 in which the electric power distributed to the separate device 40 is reduced depending on the status of power supply and power consumption.

### Continuously Energized Functions

Continuously energized functions are functions that, in principle, operate by using electric power continuous supplied. Examples of continuously energized functions include the battery 160 and the separate device 40. That is, the battery 160 and separate device 40 are continuously supplied with electric power.

As described above, the battery 160 and the separate device 40 have a power storage function. Through continuous supply of electric power to the power storage function of the battery 160 and the power storage function of the separate device 40 by using continuously energized functions, the charging time of the battery 160 and the separate device 40 can be shortened.

### (Step S120)

The distribution control module 102 adjusts the supply of electric power to the continuously energized functions. For example, at a time t2 shown in FIG. 3, the distribution control module 102 supplies electric power to the periodically energized functions, and hence reduces the electric power supplied to the continuously energized functions.

### (Step S130)

The distribution control module 102 adjusts the supply of electric power to the periodically energized functions. For example, at the time t2 shown in FIG. 3, the distribution control module 102 supplies electric power to the periodically energized functions in an amount corresponding to the reduction in electric power supplied to the continuously energized functions.

That is, at the time t2, the printing control module 104 switches the power distribution state from the first state ST1, in which the electric power distributed to the separate device 40 is not reduced, to the second state ST2, in which the electric power distributed to the separate device 40 is reduced.

When it is not required to supply electric power to the periodically energized functions, the distribution control module 102 omits the power reduction processing for the continuously energized functions.

### Specific Example of Power Distribution Plan

The distribution control module 102 creates a power distribution plan as follows. In the following description, the meaning of each of W, Wc1, Wc2, Wr, and Wp is as follows.
W: Of the electric power available to be supplied by the power supply unit 110, the electric power that is available to be supplied to continuously energized functions (for example, battery 160, separate device 40), periodically energized functions (for example, wireless communication module 180, sheet detection sensor 150), and printing functions (for example, print head 130 and sheet conveyance motor 140)
Wc1: Electric power supplied to continuously energized functions when output is not reduced
Wc2: Electric power supplied to continuously energized functions when output is reduced
Wr: Electric power supplied to periodically energized function
Wp: Electric power supplied to printing functions

When the electric power calculated by using Equation (1) is more than Wc1, the distribution control module 102 sets the electric power of the continuously energized functions to Wc2 or less.

$$Wc 2 = W - Wr \qquad ( 1 )$$

When the electric power calculated by using Equation (2) is more than Wc1, the distribution control module 102 sets the electric power of the continuously energized functions to Wc2 or less.

$$Wc 2 = W - ( Wr + Wp ) \qquad ( 2 )$$

At the end timing of the power distribution process (for example, a time t3 of FIG. 3), the distribution control module 102 stops the supply of electric power to the periodically energized functions and returns the supply of electric power to the continuously energized functions, which had been reduced, to the non-reduced state. That is, at the time t3, the printing control module 104 switches the power distribution state from the second state ST2, in which the electric power distributed to the separate device 40 is reduced, to the first state ST1, in which the electric power distributed to the separate device 40 is not reduced. As a result, at a time t4, the supply of electric power to the continuously energized functions using unreduced electric power is resumed.

Returning to FIG. 2, the control device 100 ends the series of steps in the power distribution process, and waits for the start timing of the next power distribution process (for example, the time t8 of FIG. 3).

Next, description is given of a process performed when the printing control module 104 determines in Step S20 that a printing operation instruction has been received (“YES” in Step S20).

The acquisition module 101 acquires print data D1 at a time t5 of FIG. 3. The printing control module 104 instructs the rendering data generation module 103 to generate rendering data D2 at a time t6. The rendering data generation module 103 generates the rendering data D2 from a time t6 to a time t7.

Here, at the time t7, which is when the generation of the rendering data D2 ends, the printing control module 104 suspends driving of the print head 130 and the sheet conveyance motor 140 until the power distribution process, which operates asynchronously with respect to the generation of the rendering data D2, is started.

That is, during the period in which the power distribution process maintains the power distribution state in the first state ST1 (state in which supply of electric power to continuously energized functions is not reduced), electric power is not available to drive the print head 130 or the sheet conveyance motor 140. Therefore, the printing control module 104 suspends driving of the print head 130 and the sheet conveyance motor 140 until the power distribution process switches the power distribution state from the first state ST1 to the second state ST2 (state in which supply of electric power to continuously energized functions is reduced).

In other words, when the rendering data D2 generation operation ends before the printing control module 104 switches from the first state ST1 to the second state ST2, the printing control module 104 suspends the start of the printing operation by the print head 130 until switching from the first state ST1 to the second state ST2.

### (Step S10)

At the time t8 shown in FIG. 3, the printing control module 104 determines whether or not the print head 130 or the sheet conveyance motor 140 is currently being driven. When the printing control module 104 determines that the print head 130 or the sheet conveyance motor 140 is currently being driven (or is currently energized) (“YES” in Step S10), the power distribution process ends. An example of a case in which the print head 130 or the sheet conveyance motor 140 is currently being driven (or is currently energized) is when printing is in progress. That is, in a case in which printing is in progress at the timing when the power distribution process is started, the printing control module 104 does not switch the distribution of electric power.

In contrast, when the printing control module 104 determines that the print head 130 or the sheet conveyance motor 140 is not being driven (or is not energized) (“NO” in Step S10), the printing control module 104 advances the process to Step S20.

### (Step S20)

At the time t8, the printing control module 104 determines whether or not a printing operation instruction has been received from the host device 30. As described above, at the time t8, the acquisition module 101 acquires print data D1 from the host device 30, and rendering data D2 is generated by the rendering data generation module 103. That is, at the time t8, a printing operation instruction has been received from the host device 30. In this case, the printing control module 104 advances the process to Step S210.

### (Step S210)

The distribution control module 102 executes a power distribution plan. The power distribution plan in Step S210 differs from that in Step S110 described above in terms of the point that the plan involves supplying electric power to the printing functions (for example, the print head 130 and the sheet conveyance motor 140).

### (Step S220)

The distribution control module 102 adjusts the supply of electric power to the continuously energized functions. For example, at a time t9 shown in FIG. 3, the distribution control module 102 stops the supply of electric power to the continuously energized functions in order to supply electric power to the printing functions and the periodically energized functions.

### (Step S230)

The distribution control module 102 adjusts the supply of electric power to the periodically energized functions. For example, at the time t9 shown in FIG. 3, the distribution control module 102 supplies, to the periodically energized functions, a part of the electric power that has stopped being supplied to the continuously energized functions.

### (Step S240)

The distribution control module 102 adjusts the supply of electric power to the printing functions. For example, at the time t9 shown in FIG. 3, the distribution control module 102 supplies, to the printing functions, the remaining amount of electric power obtained by subtracting the electric power supplied to the periodically energized functions from the electric power that has stopped being supplied to the continuously energized functions.

At the end timing of the power distribution process (for example, a time t10 of FIG. 3), the distribution control module 102 stops the supply of electric power to the periodically energized functions. At this time, the printing functions (print head 130 and sheet conveyance motor 140) are still being driven. Therefore, the distribution control module 102 continues the supply of electric power to the printing functions.

The printing control module 104 ends printing processing at a time t11. As a result, power consumption by the printing functions (print head 130 and sheet conveyance motor 140) ends at the time t11. Meanwhile, at the time t11, the supply of electric power to the continuously energized functions remains stopped. This is because the supply of electric power to the continuously energized functions is not resumed until the distribution control module 102 executes the power distribution process at the next timing (for example, the time t12). That is, during the printing operation, the distribution control module 102 does not switch from the second state ST2 (state in which supply of electric power to continuously energized functions is reduced or stopped) to the first state ST1 (state in which supply of electric power to continuously energized functions is not reduced). After the printing operation ends (for example, at a time t13), the distribution control module 102 switches from the second state ST2 (state in which supply of electric power to continuously energized functions is reduced or stopped) to the first state ST1 (state in which supply of electric power to continuously energized functions is not reduced).

In other words, when the printing operation by the print head 130 has started, the distribution control module 102 does not switch from the second state ST2 to the first state ST1 until the printing operation ends, and switches from the second state ST2 to the first state ST1 after the printing operation ends.

As described above, with the printing apparatus 10 according to the at least one embodiment, when the power supply capacity of the power supply unit 110 is limited, the electric power of each component of the printing apparatus 10 can be appropriately distributed in accordance with the operation of the printing apparatus 10. Therefore, the printing apparatus 10 can use a less expensive power supply circuit that has a lower rated power, while simultaneously supplying electric power (for example, supplying electric power for charging) to the separate device 40, such as a portable charger, a smartphone, or a tablet device, and performing a printing operation.

Further, the printing apparatus 10 according to the at least one embodiment executes a power distribution process as periodic processing that can be executed even by a processor having a relatively low processing power compared to interrupt processing. Therefore, with the printing apparatus 10 according to the at least one embodiment, the control device 100 can be manufactured with inexpensive components that consume less electric power.

In addition, the printing apparatus 10 according to the at least one embodiment executes printing processing in two stages, that is, a stage for generating rendering data D2 (first stage) and a stage for driving printing functions (second stage). The printing apparatus 10 configured as described above can generate the rendering data D2 immediately after acquiring the print data D1, and hence the printing operation can be started immediately after the supply of electric power to the continuously energized functions is reduced or stopped by the power distribution process. Therefore, the printing apparatus 10 according to the at least one embodiment can reduce a delay in the start of the printing operation.

In the above, the at least one embodiment of the present invention has been described in detail with reference to the accompanying drawings. However, specific configurations of the present invention are not limited to those of the at least one embodiment and encompass design modifications and the like without departing from the gist of the present invention.

For example, a computer program for implementing the functions of each of the above-mentioned devices may be recorded on a computer-readable recording medium, and the program recorded on the recording medium may be read into a computer system and executed. The term “computer system” may encompass OSs as well as peripheral equipment and other types of hardware.

The “computer-readable recording medium” as used herein refers to a flexible disk, a magneto-optical disc, a ROM, a writable non-volatile memory such as a flash memory, a portable medium such as a digital versatile disc (DVD), or a storage device such as a hard disk drive built in a computer system.

The term “computer-readable recording medium” also encompasses what holds a program for a given period of time, such as a volatile memory (such as a dynamic random access memory (DRAM)) inside a computer system that serves as a server or a client when a program is transmitted over the Internet or a similar network or via a telephone line or a similar communication line.

The program described above may be transmitted from a computer system in which the program is stored in a storage device or the like to another computer system via a transmission medium or on transmission waves in a transmission medium. The “transmission medium” through which the program is transmitted as used herein refers to a medium having a function of transmitting information, such as the Internet or a similar network (a communication network), or a telephone line or a similar communication line (a communication wire).

The program described above may also be a program for implementing some of the functions described above. The program described above may also be what is called a differential file (a differential program), with which the functions described above can be implemented by being used in combination with a program already recorded in the computer system.

What is claimed is:

1. A printing apparatus, comprising:
a power supply unit configured to supply electric power to a print head configured to perform printing based on rendering data, a control device which includes a rendering data generation module configured to generate the rendering data from print data provided from a host device, and a separate device which is a device other than the print head and the control device; and
a distribution unit configured to distribute the electric power supplied by the power supply unit to the control device, the print head, and the separate device,
the control device including:
an acquisition module configured to acquire the print data;
a distribution control module configured to switch between a first state in which the electric power distributed to the separate device is not reduced and a second state in which the electric power distributed to the separate device is reduced, at an asynchronous timing with respect to an acquisition timing of the print data; and
a printing control module configured to start, after receiving the print data, a rendering data generation operation by the rendering data generation module to generate the rendering data from the print data in the first state, and to start, after switching from the first state to the second state, a printing operation by the print head based on the rendering data.

2. The printing apparatus according to claim 1, wherein the printing control module is configured to suspend, when the rendering data generation operation ends before switching from the first state to the second state, start of the printing operation by the print head until switching from the first state to the second state.

3. The printing apparatus according to claim 1, wherein when the printing operation by the print head has started, the distribution control module is configured to avoid switching from the second state to the first state until the printing operation ends, and to switch from the second state to the first state after the printing operation ends.

4. The printing apparatus according to claim 1, wherein the asynchronous timing is a periodic timing.

5. The printing apparatus according to claim 1, wherein a function operating in the second state includes at least one of a detection unit configured to detect an operating state of the printing apparatus by using the electric power supplied, or a wireless communication unit configured to perform wireless communication to and from an external device by using the electric power supplied.

6. The printing apparatus according to claim 1, wherein the separate device is a device which has a function of storing electric power supplied from the power supply unit.

7. A program for causing a computer of a printing apparatus including:
a power supply unit configured to supply electric power to a print head configured to perform printing based on rendering data, a control device which includes a rendering data generation module configured to generate the rendering data from print data provided from a host device, and a separate device which is a device other than the print head and the control device; and
a distribution unit configured to distribute the electric power supplied by the power supply unit to the control device, the print head, and the separate device,
to execute:
acquiring the print data;
switching between a first state in which the electric power distributed to the separate device is not reduced and a second state in which the electric power distributed to the separate device is reduced, at an asynchronous timing with respect to an acquisition timing of the print data; and
starting, after receiving the print data, a rendering data generation operation by the rendering data generation module to generate the rendering data from the print data in the first state, and starting, after switching from the first state to the second state, a printing operation by the print head based on the rendering data.
